(19) United States
(12) Patent Application Publication
(10) Pub. No.: US 2024/0311198 A1
(43) Pub. Date: Sep. 19, 2024

(54) OPTIMIZING ALLOCATION OF GRAPHICAL PROCESSING UNIT (GPU) RESOURCES IN A PRODUCTION WORKSPACE

(71) Applicant: PAYPAL, INC., San Jose, CA (US)

(72) Inventor: Xidong Chen, Shanghai (CN)

(21) Appl. No.: 18/348,166

(22) Filed: Jul. 6, 2023

(30) Foreign Application Priority Data
Nov. 29, 2022 (WO) PCT/CN2022/135165

(51) Int. Cl. G06F 9/50

(52) U.S. Cl. CPC G06F 9/5044; G06F 9/5011

(57) ABSTRACT

A first machine learning task having a first data size is executed via virtualized computing resource units in a research workspace. The first machine learning task is associated with the virtualized computing resource units and with an amount of execution time. A second machine learning task is executed in a production workspace having a plurality of physical computing resource units. The second machine learning task has a same algorithm as the first machine learning task and a second data size greater than the first data size. A subset of the physical computing resource units is allocated for the execution of the second machine learning task in the production workspace. The allocating is based on the virtualized computing resource units used during an execution of the first machine learning task in the research workspace and the amount of execution time of the first machine learning task in the research workspace.

### CROSS-REFERENCE TO RELATED APPLICATIONS

This application claims priority to and the benefit of International Patent Application No. PCT/CN2022/135165, filed Nov. 29, 2022, the contents of which are hereby incorporated by reference herein in its entirety.

### BACKGROUND

### Field of the Invention

The present disclosure generally relates to allocating resources of computer processors. More specifically, the present disclosure relates to optimizing the allocation of computing resources (e.g., Graphics Processing Unit (GPU)) in a production workspace, so that a utilization rate of the computing resources is increased.

### Related Art

Rapid advances have been made in the past several decades in the fields of computer technology and artificial intelligence. For example, GPU cards—as an example of computer processors—have been used to perform tasks associated with data analysis, such as machine learning model training, the non-limiting examples of which may include image classification, video analysis, natural language processing, etc. Since GPU cards are expensive, it is desirable to fully utilize the resources of the GPU cards (e.g., with as low of an idle rate as possible for the GPU cards). However, existing schemes of using GPU cards to perform machine learning model training have not optimized the allocation of the computing resources of the GPU cards. Consequently, the GPU cards (or portions thereof) may have an excessively high idle rate, which leads to undesirable waste.

Therefore, although existing schemes of allocating computing resources have been generally adequate for their intended purposes, they have not been entirely satisfactory in every aspect.

### BRIEF DESCRIPTION OF THE DRAWINGS

The accompanying drawings, which are included to provide further understanding and are incorporated in and constitute a part of this specification, illustrate disclosed embodiments and, together with the description, serve to explain the principles of the disclosed embodiments. In the drawings:

FIG. 1 is a block diagram that illustrates a process of determining computing resource allocation according to various aspects of the present disclosure.

FIG. 2 is a block diagram of a networked system that provides an example context in which computing resources may be allocated according to the various aspects of the present disclosure.

FIG. 3 illustrates an example neural network for machine learning.

FIG. 4 illustrate flowcharts of methods according to various aspects of the present disclosure.

FIG. 5 illustrates an example computing architecture for performing various aspects of the present disclosure.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized, and structural and functional modifications may be made without departing from the scope described herein. Various aspects are capable of other embodiments and of being practiced or being carried out in various different ways.

Rapid advances in the fields of computer technology have produced increasingly powerful computer processors, such as Graphics Processing Units (GPUs). One advantage of GPUs is that they are configured for parallel processing, which is suitable for processing vast amounts of data typically involved in artificial intelligence (AI), such as in a machine learning context. GPU cards are expensive, and therefore it is desirable to utilize them fully when the vast amounts of data need to be processed in a production environment. However, existing schemes of allocating GPU resources have not been able to accurately predict how much GPU resources are needed to execute each task (e.g., a given machine learning job). As a result, significant portions of a GPU card (that has been assigned to execute a data analysis task) may sit idly, which is a waste of precious GPU resources.

The present disclosure overcomes the above problems with the use of a research workspace that is configured for research and/or experimentation, as well as a production workspace that is used in an actual production environment. For example, a first version of a data analysis task (e.g., a machine learning job with a small amount of training data) is first executed in a research workspace. The research workspace may have a plurality of virtualized resource units that each correspond to a small amount of computing resources offered by a physical device. For example, each of the virtualized resource units may represent an amount of processing power equivalent to a small fraction of a physical GPU card. Statistics may be gathered from the execution of the first version of the data analysis task. For example, the gathered statistics may include a size of the training data, the number of the virtualized resource units used to execute the task, the idle rate of the virtualized resource units during the execution, the total amount of execution time, etc. A second version of the data analysis task (e.g., a machine learning job with the same algorithm as the one executed in the research workspace but with a much greater amount of training data) may then be sent to the production workspace for execution. The statistics gathered via the research workspace may then be used to determine the resource allocation for the second version of the data analysis task in the production workspace. For example, if a maximum amount of time for completing the second version of the data analysis task in the production workspace is specified (e.g., by a Service Level Agreement (SLA)), a calculation may be made as to how many physical GPU cards, and/or what portions of the physical GPU cards, should be allocated to execute the second version of the data analysis task in order for the task to be completed within the specified amount of time. Such a calculation is made so that the idle rate of the GPU cards is low (e.g., a high utilization rate of the GPU cards), which reduces waste of resources and improves efficiency. As such, the concepts of the present disclosure are directed to improvements in computer technology. since the computing resources such as physical GPU cards are allocated to the relevant data analysis tasks with enhanced precision. In addition, since electronic resource waste is reduced, the overall cost associated with the architecture of the present disclosure is also reduced.

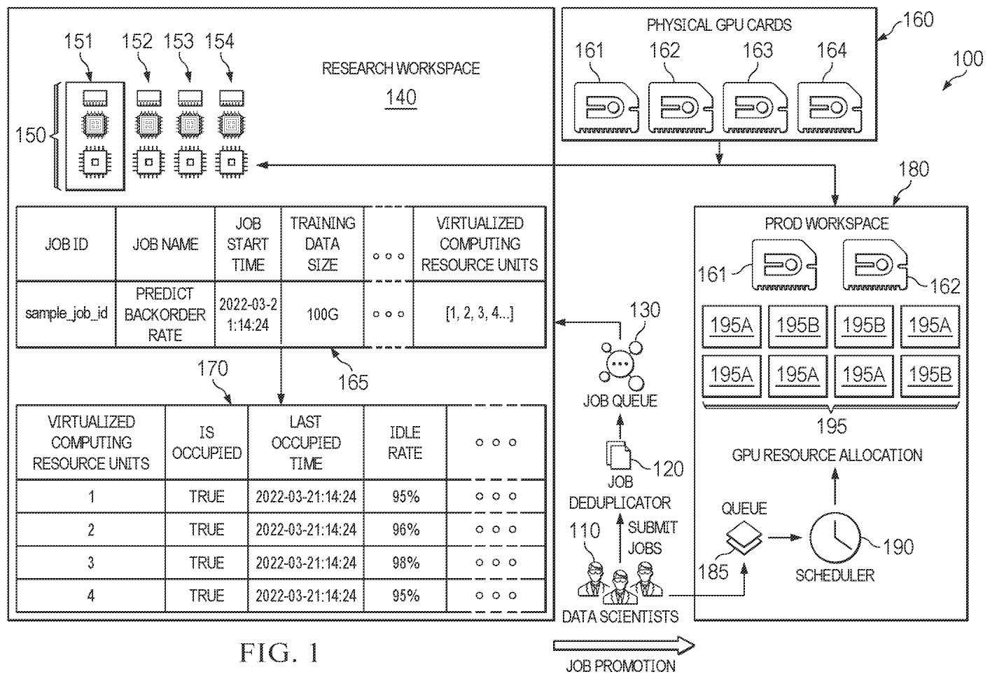

FIG. 1 illustrates a simplified block diagram of a process flow 100 for optimizing computing resource allocation according to an embodiment of the present disclosure. The process flow 100 begins when one or more data scientists 110 submit one or more jobs for data analysis. The data scientists 110 may include personnel or computing systems, such as artificial intelligence (AI) systems, from a suitable entity, for example, a commercial entity (e.g., a publicly-held or a privately-held company), a government agency, a non-profit organization, or a person not affiliated with any of the above. The one or more jobs submitted by the one or more data scientists 110 for data analysis may include tasks pertaining to machine learning, for example, training a machine learning model for image classification, video analysis, natural language processing, or making predictions. In some embodiments, these tasks involve computationally-intensive matrix operations, which is suitable for the parallel architectures offered by certain types of computer processors, such as graphics processing unit (GPU) cards. As such, it may be expedient to use GPU cards to perform the data analysis associated with the jobs submitted by the data scientists 110. GPU cards are expensive, and therefore it is desirable to increase the utilization rate of the GPU cards and to maximize efficiency. One aspect of the present disclosure pertains to optimizing the computing resource allocation for the GPU cards, as will be discussed in more detail below.

Still referring to FIG. 1, the jobs submitted by the data scientists are received and processed by a job de-duplicator 120. In some embodiments, the job de-duplicator 120 includes a software program that is configured to electronically screen for jobs that are duplicative of one another. Duplicative jobs may occur when one of the data scientists 110 submits the same job multiple times, which may or may not be done inadvertently. Processing the duplicative jobs will not improve the end result but will waste processing resources. As such, the job de-duplicator 120 is configured to remove the duplicative copies of the same job(s). In this manner, the job de-duplicator 120 serves as a filter that allows original (and therefore, wanted) jobs to go through but blocks the duplicative (and therefore, unwanted) jobs from further processing.

The jobs that come through the job de-duplicator 120 (e.g., the jobs that were not removed by the job de-duplicator 120) are then sent to a job queue 130 according to the process flow 100. In some embodiments, the job queue 130 includes a temporary data storage, in which the jobs may temporarily reside before they are sent away for further processing. In some embodiments, the job queue 130 may employ a first-in-first-out (FIFO) methodology for receiving and outputting the jobs. In other embodiments, the job queue 130 may employ alternative methodologies that are different from the FIFO methodology. For example, the jobs may be designated with their respective priority levels. The jobs that have higher priority levels may be outputted sooner than the jobs that have lower priority levels.

Still referring to FIG. 1, the jobs that leave the job queue 130 are sent to a research workspace 140 when resources within the research workspace 140 become available to execute the jobs that leave the job queue 130. In some embodiments, the research workspace 140 includes a type of a non-production workspace. For example, the research workspace 140 focuses on data analysis tasks (e.g., the jobs submitted by the data scientists 110) that are still in a development phase, but that have not yet been promoted to a production environment (discussed below in more detail). In some embodiments, the present disclosure utilizes the research workspace 140 as a testing ground for various types of data analysis tasks, and the data analysis tasks are performed on a smaller scale than in an actual production environment. The research workspace 140 may also not have the strict requirements or specifications that are typically associated with an actual production environment. For example, whereas an actual production environment may specify that a particular data analysis task should be completed within a predefined amount of time, the research workspace 140 may lack such a requirement, so that the data scientist may elect to run a data analysis task for as long as needed in order to obtain satisfactory results. The present disclosure will monitor the execution of each data analysis task within the research workspace 140 and use the monitored results to predict how computing resources should be allocated in the actual production environment later, as discussed below in more detail.

Due to the unique nature of the research workspace 140, the present disclosure configures the computing resources allocated to the research workspace 140 by virtualizing them into a plurality of small units. For example, in the embodiment shown in FIG. 1, the research workspace 140 includes a plurality of virtualized computing resource units 150, four of which are illustrated herein as virtualized computing resource units 151, 152, 153, and 154 as simplified non-limiting examples. In some embodiments, each of the virtualized computing resource units 151-154 may include a virtualized GPU, a virtualized Central Processing Unit (CPU), and a virtualized electronic memory (e.g., a virtualized hard disk or a virtualized Random Access Memory (RAM)). In some embodiments, the virtualized GPU may correspond to a small portion (e.g., 1%, 0.1%, 0.01%, etc.) of a physical GPU card (e.g., one of the physical GPU cards 161, 162, 163, or 164) and may therefore have a fraction of the computing processing power of the physical GPU card accordingly. In some embodiments, the virtualized GPU may include small portions of the computing resources of multiple hardware GPU cards. For example, the virtualized GPU may include a small portion of the physical GPU card 161, as well as a small portion of the GPU card 162. Although the virtualized GPU may not encompass a physical GPU card in its entirety, it may still function as a physical GPU from the perspective of the data analysis jobs that are performed within the research workspace 140. In some embodiments, a microcontroller or another suitable controller device may be utilized to manage the virtualized GPU.

Similarly, the virtualized CPU and the virtualized electronic memory may include small portions of one or more physical CPU cards and one or more physical electronic memory, respectively. In that regard, the physical CPU cards and/or electronic memory may be considered parts of physical computing resources 160 that also includes the physical GPU cards 161-164. In some embodiments, the physical computing resources 160 may includes computing resources (e.g., GPUs, CPUs, electronic memories) in a centralized environment, such as a data center. In other embodiments, the physical computing resources 160 may include computing resources (e.g., GPUs, CPUs, electronic memories) in a decentralized environment, such as in an edge computing environment. For example, edge computing may refer to a computing paradigm that performs computing and/or data storage at nodes that are at or close to the end users, where the sources of data originate. Since edge computing allows computing of the data to be closer to the sources of the data, the computing may be done at greater speeds and/or larger volumes. As a result, response times and/or bandwidth may be improved.

In any case, regardless of what is included in the physical computing resources 160 or its context, it is understood that the virtualized computing resource units 151-154 each correspond to a small fraction (e.g., a fraction substantially less than 1) of the processing power offered by the physical computing resources 160. In some embodiments, additional and/or different types of computer hardware (e.g., other than CPU, GPU, or electronic memory) may also be included in each of the virtualized computing resource units 151-154. In addition, although four of such virtualized computing resource units 151-154 are illustrated herein for reasons of simplicity, it is understood that many more of the virtualized computing resource units 151-154 (e.g., hundreds, thousands, or tens of thousands) may be implemented in the research workspace 140. Furthermore, it is understood that although the virtualized computing resource units 151-154 illustrated in FIG. 1 may be substantially identical to one another in terms of the types of virtualized hardware included therein and/or the amount of computer processing power or electronic storage space, the virtualized computing resource units 151-154 in alternative embodiments may be implemented to differ from one another as well. For example, the virtualized computing resource unit 151 may include a type of virtualized hardware device (e.g., CPU) that is not included in the rest of the virtualized computing resource units 152-154, or vice versa. As another example, the virtualized computing resource unit 151 may have more processing power (or a greater percentage of a physical GPU card) than the rest of the virtualized computing resource units 152-154, or vice versa.

Regardless of how many virtualized computing resource units are implemented, or what type of virtual resources are included in each of then, it is understood that they may be utilized individually or collectively to execute the data analysis tasks within the research workspace 140. For example, one of the jobs that is sent to the research workspace 140 may include a job 165, which may include a plurality of attributes. As a non-limiting example herein, the job 165 has a job identifier (ID) that is “sample_job_id.” Such a job ID is used to identify the job 165 from a plurality of other jobs in the research workspace 140. The job 165 has a job name that is “predict backorder rate.” As the name indicates, a goal of the job 165 is to make a specific prediction, for example, a backorder rate of a product inventory of a particular merchant. The job 165 has a job start time that is “2022-03-21:14:24”, which indicates that the execution of the job 165 began on the date of March 21 of the year 2022, at the time of 14:24. The job 165 has a training data size of “100G”, which indicates there is a hundred gigabytes of data in the training data associated with the job 165. The job 165 has virtualized computing resource units “[1,2,3,4]”, which indicates that the virtualized computing resource units 151-514 (which correspond to the “virtualized computing resource units [1, 2, 3, 4]” herein) are used to execute the job 165. The job 165 may also have a plurality of other attributes, but these attributes are not specifically discussed herein for reasons of simplicity.

The research workspace 140 keeps electronic records of each job executed therein and the combinations of virtualized computing resource units utilized to execute the jobs. In some embodiments, these electronic records are maintained in the form of a table 170, which is shown in FIG. 1 and also reproduced below.

| virtualized | | Last | | |
|---|---|---|---|---|
| computing | Is | occupied | Idle | |
| resource units | occupied? | time | rate | . . . |
| 1 | TRUE | 2022 Mar. 21 | 95% | . . . |
| | | 14:24 | | |
| 2 | TRUE | 2022 Mar. 21 | 96% | . . . |
| | | 14:24 | | |
| 3 | TRUE | 2022 Mar. 21 | 98% | . . . |
| | | 14:24 | | |
| 4 | TRUE | 2022 Mar. 21 | 95% | . . . |
| | | 14:24 | | |

The table 170 includes a plurality of rows, where each row includes the data of a record for a different one of the virtualized computing resource units 1-4 (e.g., corresponding to the virtualized computing resource units 151-154). The table 170 also includes a plurality of columns, where each column represents a different aspect of the records. For example, the column “virtualized computing resource units” lists the names of the virtualized computing resource units (e.g., the virtualized computing resource units 151-154) used to execute the job 165. The column “Is occupied” lists the occupied status of each of the different ones of the virtualized computing resource units 1-4. For example, a status of “TRUE” indicates that the corresponding virtualized computing resource unit is occupied (e.g., being utilized to execute the job 165). Conversely. A status of “FALSE” indicates that the corresponding virtualized computing resource unit is not used to execute the job 165. The column “Last occupied time” indicates the date and time in which the corresponding virtualized computing resource unit is utilized to execute the job 165. The column “Idle rate” indicates a percentage of time in which the corresponding virtualized computing resource unit is in an idle position, rather than being used to execute the job 165. For example, an idle rate of 95% for the virtualized computing resource unit 1 means that 95% of the time, the virtualized computing resource unit 151 is not being used to execute the job 165. Alternatively stated, the idle rate of 95% indicates that the virtualized computing resource unit 151 is used 5% of the time to execute the job 165. It is understood that the idle rate may be replaced by a utilization rate in alternative embodiments. In that case, a column of “utilization rate” would be 5%, 4%, 2%, and 5% in the example herein. In some embodiments, the table 170 may include both an idle rate and a utilization rate. Of course, it is understood that a goal of the present disclosure is to increase the utilization rate and to decrease the idle rate, so as to increase the efficiency and to reduce the waste of using the computing resources to perform data analysis. The table 170 may include additional columns that represent additional aspects of the records kept for the virtualized computing resource units 1-4 during their execution of the job 165. However, these additional columns are not discussed herein for reasons of simplicity. The content of the records maintained by the table 170 may also be referred to as the meta-data of the job 165.

In some embodiments, the table 170 is dynamically updated (e.g., in real-time) throughout the execution of the job 165 in the research workspace 140. At some point, the job 165 may be completed. In some embodiments, the execution of the job 165 may be deemed complete when the data scientist 110 that submitted the job 165 sends an indication to the research workspace 140. For example, the data scientist 110 may trigger the indication by pressing a button in a software program interface configured to interact with the research workspace 140. This may occur when the data scientist 110 is satisfied with the results of the job 165. For example, the job 165 may offer a backorder prediction accuracy above a threshold defined by the data scientist 110.

Regardless of how the job 165 is completed, the data maintained by the table 170 for the job 165 may be useful when computing resources need to be allocated to jobs similar to the job 165 in a production environment. For example, if a job that is much larger in size but otherwise substantially identical in terms of algorithm to the job 165 needs to be executed in a production environment, the amount of computing resources needed to execute that job may be calculated based on the larger data size of that job, the data size of the job 165, and the computing resources used to execute the job 165 in the research workspace 140. In some embodiments, the amount of computing resources needed to execute the larger job may be extrapolated based on a linear relationship with the amount of computing resources used to execute the job 165 in the research workspace 140, as will be discussed in later below.

Still referring to FIG. 1, when the job 165 is completed, the research workspace 140 may call a promotion to the job 165 to send the job 165 and its meta-data to a production workspace 180. In contrast to the research workspace 140, the production workspace 180 corresponds to an actual production environment where the jobs are executed based on real-world needs. For example, whereas the research workspace 140 is used mainly for the purposes of research and/or experimentation, the production workspace 180 is used to execute tasks in a real-world environment with various requirements, such as timing constraints specified by a Service Level Agreement (SLA). In the case of the job 165, the SLA may specify that the backorder prediction needs to be made within a specified number of seconds. Due to these requirements, it is desirable to optimize the resource allocation within the production workspace 180, so that it can execute the jobs therein under the given timing constraints while not wasting any computing resources.

When the job 165 is promoted and sent to the production workspace 180, it may include a substantially similar version (e.g., in terms of algorithm) of the task that was submitted to and executed in the research workspace 140, but with a substantially larger data size. For example, whereas the job 165 in the research workspace 140 has 100 gigabytes of data, the promoted version of the job 165 send to the production workspace 180 may have terabytes, petabytes, or exabytes of data. Due to the large size of the data of the promoted version of the job 165, its execution may involve multiple physical GPU cards 161-164 and the resource allocation of which may need to be optimized. As discussed below in more detail, such a resource allocation optimization may include extrapolating, based on the computing resources used to execute the original version of the job 165 and difference between the data sizes of the original version of the job 165 and the promoted version of the job 165, the amount of computing resources needed to execute the promoted version of the job 165.

When the promoted version of the job 165 is sent to the production workspace 180, it first resides in a queue 185. Similar to the job queue 130, the queue 185 may include a temporary data storage, so that the promoted version of the job 165 (along with other jobs) can be stored therein before they can be executed when the computing resources of the production workspace 180 become available.

The production workspace 180 allocates computing resources to execute the promoted version of the job 165 via a scheduler 190. The scheduler 190, which may include a software program in some embodiments, has access to the physical computing resources 160. For example, the scheduler 190 can assign portions of any one of the physical GPU cards 161-163 to any job that needs to be executed by the production workspace 180. To reduce waste, it is desirable to lower the idle rate of the physical GPU cards. Unfortunately, existing systems may not be able to provide an accurate estimate of how much GPU resources are needed to execute any given job. As a result, too much GPU resources may be allocated for a job, which results in a high idle rate of the physical GPU cards and therefore unnecessary waste of GPU resources. Alternatively, not enough GPU resources are allocated for the job, which may result in an unacceptably slow execution of the job.

The present disclosure optimizes the computing resource allocation by calculating, with enhanced precision, what percentage of each of the physical GPU cards 161-164 should be allocated to any given job in the production workspace 180, based on the history of execution of the smaller version of that job in the research workspace 140. Using the job 165 as a simplified example herein, suppose that the promoted version of the job 165 that needs to be executed in the production workspace 180 has 100 petabytes of data, which is a million times greater than the 100 gigabytes of data associated with the job 165 when it was executed in the research workspace 140. Also suppose that each of the virtualized computing resource units 151-154 used to execute the job 165 in the research workspace 140 has processing power that is equal to one hundred thousandth (or 0.001%) of the processing power of a single one of the physical GPU cards 161-164. In addition, suppose that the execution of the job 165 in the research workspace 140 using the combination of the virtualized computing resource units 151-154 took 2 hours, where the virtualized computing resource units 151-154 each had an idle rate of 25% (e.g., equivalent to a utilization rate of 75%, since the utilization rate=100%-idle rate).

The scheduler 190 then uses the above data to calculate how much computing resources to allocate to the promoted version of the job 165 in the production workspace 180. In some embodiments, the maximum amount of time given to finish the execution of the promoted version of the job 165 is already known, for example, via a SLA. As a simple example, the SLA may specify that the promoted version of the job 165 should be completed within 24 hours. Since the computing resources of the virtualized computing resource units 151-154 and the computing resources of the physical GPU cards 161-164 may have a linear relationship, as does the data sizes of the original version of the job 165 executed in the research workspace 140 and the promoted version of the job 165 to be executed in the production workspace 180, the optimal computing resources allocated for the execution of the promoted version of the job 165 in the production workspace 180 may be calculated as a simple algebraic equation of:

X=A*B*C*D*E, where:
X is the number of physical GPU cards that should be allocated for the execution of the promoted version of the job 165 in the production workspace 180;
A is a ratio of: a data size of the promoted version of the job 165 in the production workspace 180 versus a data size of the original version of the job 165 in the research workspace 140;
B is a ratio of: the amount of computing resources corresponding to a single one of the virtualized computing resource units 151-154 versus the amount of computing resources corresponding to a single one of the physical GPU cards 161-164;
C is the total number of the virtualized computing resource units 151-154 used to execute the original version of the job 165 in the research workspace 140;
D is a ratio of: the total amount of time it took to complete the execution of the original version of the job 165 in the research workspace 140 versus a maximum amount of time given to finish the execution of the promoted version of the job 165 in the production workspace 180; and
E is a ratio of: an average utilization rate of the virtualized computing resource units 151-154 versus a desired average utilization rate of the allocated physical GPU cards 161-164 used to execute the promoted version of the job 165 in the production workspace 180. For the sake of simplicity, it is assumed that the desired average utilization rate of the allocated portions of the physical GPU cards 161-164 is 100% (e.g., 0% idle rate).
   In this Case:

$$A = ( 100 petabytes / 100 gigabytes ) = 1 , 000 , 000 ; \\ B = 0.001 \% ; \\ C = 4 ; \\ D = ( 2 hours / 24 hours ) = 1 / 12 ; and \\ E = ( 75 \% / 100 \% ) = 0.75 .$$

Based on the above numbers, X=1,000,000*0.001%*4*(1/12)*0.75=2.5. This means that 2.5 physical GPU cards 161-164 should be allocated to the production workspace 180 to ensure that the promoted version of the job 165 can be completed within the allotted time (e.g., 24 hours in this simplified example). In some embodiments, the number X may be adjusted upwards slightly, for example, by a predefined percentage (e.g., 1% to 10%), in order to provide a margin of safety. For example, the margin of safety may allow the utilization rate of the allocated portions of the physical GPU cards 161-164 to fall slightly below 100% (e.g., having an idle rate slightly above 0%), and still ensure that the SLA-specified time limit of 24 hours is met.

Regardless of the exact value determined for X, it is understood that X represents the amount of computing processing power that is equivalent to the hardware processing power offered by X number of GPU cards (e.g., GPU cards 161-164). However, there are many different ways to apportion this amount of hardware processing power to execute the promoted version of the job 165 in the production workspace 180. For example, the scheduler 190 may allocate the physical GPU cards 161 and 162 in their entireties, as well as half of the physical GPU card 163, to execute the promoted version of the job 165 in the production workspace 180. As another example, the scheduler 190 may allocate the physical GPU card 161 in its entirety, as well as half of each of the physical GPU cards 162, 163, and 164, to execute the promoted version of the job 165 in the production workspace 180. As a further example, the scheduler 190 may allocate 80% of the physical GPU card 161, 70% of the physical GPU card 162, 40% of the physical GPU card 163, and 60% of the physical GPU card 164, to execute the promoted version of the job 165 in the production workspace 180. It is understood that in embodiments where a portion of a given physical GPU card 161-164 (but not the entire GPU card) is allocated, the average utilization rate discussed above may apply to the portion of the physical GPU card that is allocated. For example, if 40% of the physical GPU card 161 is allocated, then the average utilization rate of 100% discussed above may refer to the fact that the 40% of the allocated portion of the physical GPU card 161 is being utilized 100% of the time, regardless of what is happening with the rest of the physical GPU card 161 that is not allocated for the execution of the promoted version of the job 165.

In some embodiments, the physical GPU cards 161-164 may be divided into a plurality of GPU blocks 195. For example, each of the GPU blocks 195 may represent 10% (or some other suitable percentage) of a physical GPU card. These GPU blocks 195 may be substantially identical to one another and offer substantially identical processing powers as one another. As shown in FIG. 1, the GPU blocks 195A correspond to the GPU blocks that have been allocated to execute the promoted version of the job 165, and the GPU blocks 195 correspond to the GPU blocks that have not been allocated for any job. In other words, the GPU blocks 195A may be fully occupied (e.g., having an idle rate that is at or approaches 0%), whereas the GPU blocks 195B may not be fully occupied (e.g., having an idle rate that is greater than 0%). In some embodiments, as the GPU blocks 195 are allocated to any given job for execution within the production workspace 180, that job may be agnostic as to which actual GPU card the GPU blocks 195 came from, since the scheduler 190 is able to keep track of the GPU blocks 195 allocated for each job within the production workspace 180. Again, the exact apportionment of any of the available GPU cards 161-164 (or the GPU blocks 195) need not be rigid but can be flexibly configured, depending on various factors such as the existing processing bandwidth that exists at any of the physical GPU cards 161-164 at the time.

It is also understood that similar to the job 165, other jobs (e.g., other types of machine-learning jobs) may run through the research workspace 140 to allow data to be gathered on their execution, and then the promoted versions of these jobs may then be executed in the production workspace 180. The data gathered for these jobs in the research workspace 140 may be used to determine how the computing resources of the production workspace 180 should be allocated to these jobs. Since there may be multiple jobs at the production workspace 180 at any point in time, the scheduler 190 may utilize a plurality of scheduling schemes to determine the order of execution of these jobs. In some embodiments, the scheduler 190 may use a “shorter job first” scheduling scheme, in which the job with the shortest execution time (which may be allotted or projected) will be executed first. In some embodiments, the scheduler 190 may use a “round robin” scheduling scheme, in which time slots are assigned to each job (which may be done in equal portions) in a cyclic (e.g., circular) order, such that all jobs are handled without priority. In some embodiments, the scheduler 190 may use a “first-in-first-out (FIFO)” scheduling scheme, in which the job that comes out of the queue 185 first will be executed first. In some embodiments, the scheduler 190 may use a “shortest time to execute and complete first” scheduling scheme, in which the jobs that have the shortest time to be executed and completed will be executed first. In some embodiments, the scheduler 190 may use a “completely fair” scheduling scheme, which is the default scheduling algorithm in the Linux operating system.

Regardless of how the scheduler 190 schedules the different jobs and/or the exact manner in which the computing resources corresponding to the physical GPU cards 161-164 are allocated to each of the jobs in the production workspace 180, it is understood that the allocation of these resources is optimized by the present disclosure. For example, using the data gathered by executing a job with smaller data size in the research workspace 140, the amount of computing resources needed to execute a promoted version of that job with a much larger data size can be accurately determined. This allows each of the physical GPU cards 161-164 to be utilized as fully as possible, which leads to a lower idle rate and a reduction in waste of computing resources compared to existing systems.

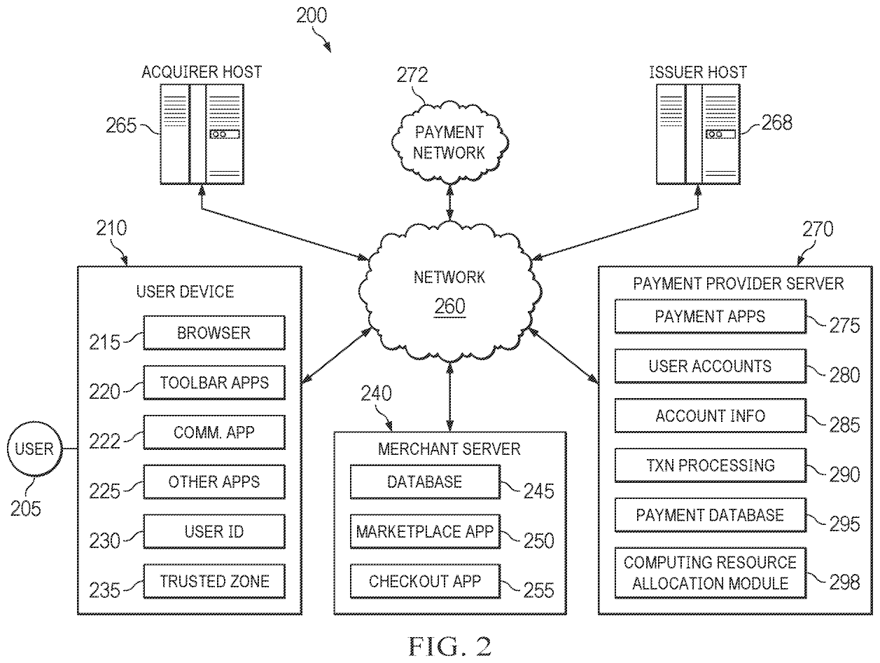

FIG. 2 is a block diagram of a networked system 200 that provides an example context in which computing resources may be allocated according to the various aspects of the present disclosure. The networked system 200 may comprise or implement a plurality of hardware devices and/or software components that operate on the hardware devices to perform various payment transactions or processes. Exemplary devices may include, for example, stand-alone and enterprise-class servers operating a server OS such as a MICROSOFT™ OS, a UNIX™ OS, a LINUX™ OS, or another suitable server-based OS. It can be appreciated that the servers illustrated in FIG. 2 may be deployed in other ways and that the operations performed, and/or the services provided by such servers may be combined or separated for a given implementation and may be performed by a greater number or fewer number of servers. One or more servers may be operated and/or maintained by the same or different entities. Exemplary devices may also include mobile devices, such as smartphones, tablet computers, or wearable devices. In some embodiments, the mobile devices may include an APPLE™ IPHONE™, an ANDROID™ smartphone, or an APPLE™ IPAD™, etc.

In the embodiment shown in FIG. 2, the networked system 200 may include a user device 210, a merchant server 240, a payment provider server 270, an acquirer host 265, an issuer host 268, and a payment network 272 that are in communication with one another over a network 260. The payment provider server 270 may be maintained by a payment service provider, such as PAYPAL™, Inc. of San Jose, CA. A user 205, such as a consumer, may utilize user device 210 to perform an electronic transaction using payment provider server 270. For example, user 205 may utilize user device 210 to initiate a payment transaction, receive a transaction approval request, or reply to the request. Note that a transaction, as used here, refers to any suitable action performed using the user device, including payments, transfer of information, display of information, etc. Although only one merchant server is shown, a plurality of merchant servers may be utilized if the user is purchasing products from multiple merchants.

User device 210, merchant server 240, payment provider server 270, acquirer host 265, issuer host 268, and payment network 272 may each include one or more electronic processors, electronic memories, and other appropriate electronic components for executing instructions such as program code and/or data stored on one or more computer readable mediums to implement the various applications, data, and steps described here. For example, such instructions may be stored in one or more computer readable media such as memories or data storage devices internal and/or external to various components of system 200, and/or accessible over network 260.

Network 260 may be implemented as a single network or a combination of multiple networks. For example, in various embodiments, network 260 may include the Internet or one or more intranets, landline networks, wireless networks, and/or other appropriate types of networks. Software programs (e.g., programs developed by the payment provider or by another entity) may be installed on the network 260 to facilitate the offer solicitation, transmission, and presentation processes discussed above. The network 260 may also include a blockchain network in some embodiments.

User device 210 may be implemented using any appropriate hardware and software configured for wired and/or wireless communication over network 260. For example, in one embodiment, the user device may be implemented as a personal computer (PC), a smart phone, a smart phone with additional hardware such as NFC chips, BLE hardware etc., wearable devices with similar hardware configurations such as a gaming device, a Virtual Reality Headset, or that talk to a smart phone with unique hardware configurations and running appropriate software, laptop computer, and/or other types of computing devices capable of transmitting and/or receiving data, such as an IPHONE™ or IPAD™ from APPLE™.

User device 210 may include one or more browser applications 215 which may be used, for example, to provide a convenient interface to permit user 205 to browse information available over network 260. For example, in one embodiment, browser application 215 may be implemented as a web browser configured to view information available over the Internet, such as a user account for online shopping and/or merchant sites for viewing and purchasing goods and/or services.

Still referring to FIG. 2, the user device 210 may also include one or more toolbar applications 220 which may be used, for example, to provide client-side processing for performing desired tasks in response to operations selected by user 205. In one embodiment, toolbar application 220 may display a user interface in connection with browser application 215.

User device 210 also may include other applications 225 to perform functions, such as email, texting, voice and IM applications that allow user 205 to send and receive emails, calls, and texts through network 260, as well as applications that enable the user to communicate, transfer information, make payments, and otherwise utilize a digital wallet through the payment provider as discussed here. In some embodiments, these other applications 225 may include a mobile application downloadable from an online application store (e.g., from the APPSTORE™ by APPLE™). The mobile application may be developed by the payment provider or by another entity, such as an offer aggregation entity. The mobile application may then communicate with other devices to perform various transaction processes. In some embodiments, the execution of the mobile application may be done locally without contacting an external server such as the payment provider server 270. In other embodiments, one or more processes associated with the execution of the mobile application may involve or be performed in conjunction with the payment provider server 270 or another entity. In addition to allowing the user to receive, accept, and redeem offers, such a mobile application may also allow the user 205 to send payment transaction requests to the payment provider server 270, which includes communication of data or information needed to complete the request, such as funding source information.

User device 210 may include one or more user identifiers 230 which may be implemented, for example, as operating system registry entries, cookies associated with browser application 215, identifiers associated with hardware of user device 210, or other appropriate identifiers, such as used for payment/user/device authentication. In one embodiment, user identifier 230 may be used by a payment service provider to associate user 205 with a particular account maintained by the payment provider. A communications application 222, with associated interfaces, enables user device 210 to communicate within networked system 200.

In conjunction with user identifiers 230, user device 210 may also include a trusted zone 235 owned or provisioned by the payment service provider with agreement from a device manufacturer. The trusted zone 235 may also be part of a telecommunications provider SIM that is used to store appropriate software by the payment service provider capable of generating secure industry standard payment credentials as a proxy to user payment credentials based on user 205's credentials/status in the payment providers system/age/risk level and other similar parameters.

Still referring to FIG. 2, the merchant server 240 may be maintained, for example, by a merchant or seller offering various products and/or services. The merchant may have a physical point-of-sale (POS) store front. The merchant may be a participating merchant who has a merchant account with the payment service provider. Merchant server 240 may be used for POS or online purchases and transactions. Generally, merchant server 240 may be maintained by anyone or any entity that receives money, which includes charities as well as retailers and restaurants. For example, a purchase transaction may be payment or gift to an individual. Merchant server 240 may include a database 245 identifying available products and/or services (e.g., collectively referred to as items) which may be made available for viewing and purchase by user 205. Accordingly, merchant server 240 also may include a marketplace application 250 which may be configured to serve information over network 260 to browser application 215 of user device 210. In one embodiment, user 205 may interact with marketplace application 250 through browser applications over network 260 in order to view various products, food items, or services identified in database 245.

Merchant server 240 also may include a checkout application 255 which may be configured to facilitate the purchase by user 205 of goods or services online or at a physical POS or store front. Checkout application 255 may be configured to accept payment information from or on behalf of user 205 through payment provider server 270 over network 260. For example, checkout application 255 may receive and process a payment confirmation from payment provider server 270, as well as transmit transaction information to the payment provider and receive information from the payment provider (e.g., a transaction ID). Checkout application 255 may be configured to receive payment via a plurality of payment methods including cash, credit cards, debit cards, checks, money orders, or the like. The merchant server 240 may also be configured to generate offers for the user 205 based on data received from the user device 210 via the network 260.

Payment provider server 270 may be maintained, for example, by an online payment service provider which may provide payment between user 205 and the operator of merchant server 240. In this regard, payment provider server 270 may include one or more payment applications 275 which may be configured to interact with user device 210 and/or merchant server 240 over network 260 to facilitate the purchase of goods or services, communicate/display information, and send payments by user 205 of user device 210.

The payment provider server 270 also maintains a plurality of user accounts 280, each of which may include account information 285 associated with consumers, merchants, and funding sources, such as credit card companies. For example, account information 285 may include private financial information of users of devices such as account numbers, passwords, device identifiers, usernames, phone numbers, credit card information, bank information, or other financial information which may be used to facilitate online transactions by user 205. Advantageously, payment application 275 may be configured to interact with merchant server 240 on behalf of user 205 during a transaction with checkout application 255 to track and manage purchases made by users and which and when funding sources are used.

A transaction processing application 290, which may be part of payment application 275 or separate, may be configured to receive information from a user device and/or merchant server 240 for processing and storage in a payment database 295. Transaction processing application 290 may include one or more applications to process information from user 205 for processing an order and payment using various selected funding instruments, as described here. As such, transaction processing application 290 may store details of an order from individual users, including funding source used, credit options available, etc. Payment application 275 may be further configured to determine the existence of and to manage accounts for user 205, as well as create new accounts if necessary.

The payment provider server 270 may also include a computing resource allocation module 298 that is configured to optimize the allocation of computing resources in accordance with the process flow 100 discussed above. For example, the computing resource allocation module 298 may include modules to configure the research workspace 140 and/or the production workspace 180, including the virtualized computing resource units 150 and the physical computing resources 160 discussed above. The computing resource allocation module 298 may leverage the statistics extracted during the execution of a data analysis task (e.g., a machine learning job) in the research workspace 140 to determine how the computing resources of physical computing devices (e.g., GPU cards) should be allocated to execute the data analysis task in the production workspace 180. It is understood that although the computing resource allocation module 298 is shown to be implemented on the payment provider server 270 in the embodiment of FIG. 2, it may be implemented on the merchant server 240 (or even the acquirer host 265 or the issuer host 268) in other embodiments.

The payment network 272 may be operated by payment card service providers or card associations, such as DISCOVER™, VISA™, MASTERCARD™, AMERICAN EXPRESS™, RUPAY™, CHINA UNION PAY™, etc. The payment card service providers may provide services, standards, rules, and/or policies for issuing various payment cards. A network of communication devices, servers, and the like also may be established to relay payment related information among the different parties of a payment transaction.

Acquirer host 265 may be a server operated by an acquiring bank. An acquiring bank is a financial institution that accepts payments on behalf of merchants. For example, a merchant may establish an account at an acquiring bank to receive payments made via various payment cards. When a user presents a payment card as payment to the merchant, the merchant may submit the transaction to the acquiring bank. The acquiring bank may verify the payment card number, the transaction type and the amount with the issuing bank and reserve that amount of the user's credit limit for the merchant. An authorization will generate an approval code, which the merchant stores with the transaction.

Issuer host 268 may be a server operated by an issuing bank or issuing organization of payment cards. The issuing banks may enter into agreements with various merchants to accept payments made using the payment cards. The issuing bank may issue a payment card to a user after a card account has been established by the user at the issuing bank. The user then may use the payment card to make payments at or with various merchants who agreed to accept the payment card.

As discussed above, the computing resource allocation scheme of the present disclosure may apply to various types of data analysis tasks, such as machine learning. In some embodiments, machine learning may be used to predict and/or detect fraud. For example, nefarious entities may pose as legitimate users such as the user 205. Using training data such as data pertaining to the user's historical or current activities and/or behavioral patterns, a machine learning model may be trained to predict whether a seemingly legitimate user may actually be a bad-faith actor seeking to perpetrate fraud. In some other embodiments, machine learning may be used to predict metrics for merchants that operate the merchant server 240. For example, based on data pertaining to sales of goods of the merchant, a machine learning model may be trained to predict when to reorder the goods to refill the merchant's inventory.

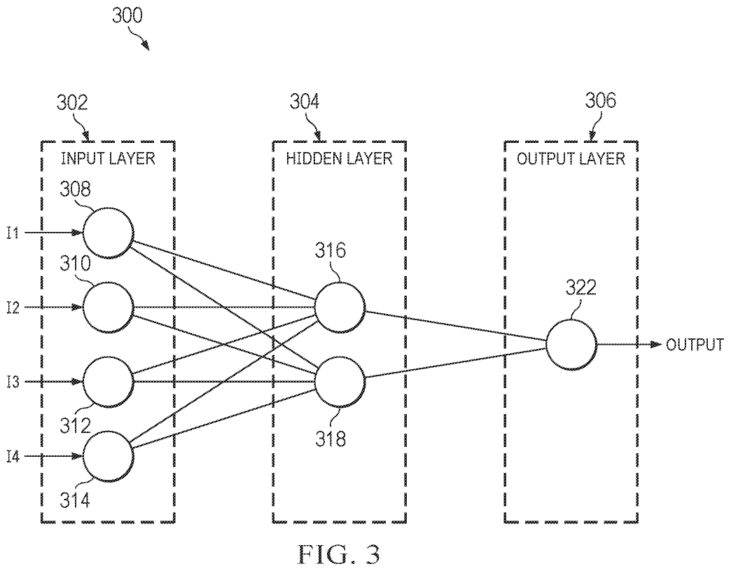

In some embodiments, the machine learning processes of the present disclosure (e.g., the job 165 discussed above with reference to FIG. 1) may be performed at least in part via an artificial neural network, an example block diagram of which is illustrated in FIG. 3. As shown in FIG. 3, the artificial neural network 300 includes three layers—an input layer 302, a hidden layer 304, and an output layer 306. Each of the layers 302, 304, and 306 may include one or more nodes. For example, the input layer 302 includes nodes 308-314, the hidden layer 304 includes nodes 316-318, and the output layer 306 includes a node 322. In this example, each node in a layer is connected to every node in an adjacent layer. For example, the node 308 in the input layer 302 is connected to both of the nodes 316-318 in the hidden layer 304. Similarly, the node 316 in the hidden layer is connected to all of the nodes 308-314 in the input layer 302 and the node 322 in the output layer 306. Although only one hidden layer is shown for the artificial neural network 300, it has been contemplated that the artificial neural network 300 used to implement machine learning modules and may include as many hidden layers as necessary. In this example, the artificial neural network 300 receives a set of input values and produces an output value. Each node in the input layer 302 may correspond to a distinct input value.

In some embodiments, each of the nodes 316-318 in the hidden layer 304 generates a representation, which may include a mathematical computation (or algorithm) that produces a value based on the input values received from the nodes 308-314. The mathematical computation may include assigning different weights to each of the data values received from the nodes 308-314. The nodes 316 and 318 may include different algorithms and/or different weights assigned to the data variables from the nodes 308-314 such that each of the nodes 316-318 may produce a different value based on the same input values received from the nodes 308-314. In some embodiments, the weights that are initially assigned to the features (e.g., input values) for each of the nodes 316-318 may be randomly generated (e.g., using a computer randomizer). The values generated by the nodes 316 and 318 may be used by the node 322 in the output layer 306 to produce an output value for the artificial neural network 300. When the artificial neural network 300 is used to implement machine learning, the output value produced by the artificial neural network 300 may indicate a likelihood of an event.

The artificial neural network 300 may be trained by using training data. For example, the training data herein may include the data pertaining to the electronic modules that is collected using various time period lengths. By providing training data to the artificial neural network 300, the nodes 316-318 in the hidden layer 304 may be trained (e.g., adjusted) such that an optimal output is produced in the output layer 306 based on the training data. By continuously providing different sets of training data and penalizing the artificial neural network 300 when the output of the artificial neural network 300 is incorrect, the artificial neural network 300 (and specifically, the representations of the nodes in the hidden layer 304) may be trained to improve its performance in data classification. Adjusting the artificial neural network 300 may include adjusting the weights associated with each node in the hidden layer 304.

Although the above discussions pertain to an artificial neural network as an example of machine learning, it is understood that other types of machine learning methods may also be suitable to implement the various aspects of the present disclosure. For example, support vector machines (SVMs) may be used to implement machine learning. SVMs are a set of related supervised learning methods used for classification and regression. A SVM training algorithm—which may be a non-probabilistic binary linear classifier—may build a model that predicts whether a new example falls into one category or another. As another example, Bayesian networks may be used to implement machine learning. A Bayesian network is an acyclic probabilistic graphical model that represents a set of random variables and their conditional independence with a directed acyclic graph (DAG). The Bayesian network could present the probabilistic relationship between one variable and another variable. Other types of machine learning algorithms are not discussed in detail herein for reasons of simplicity.

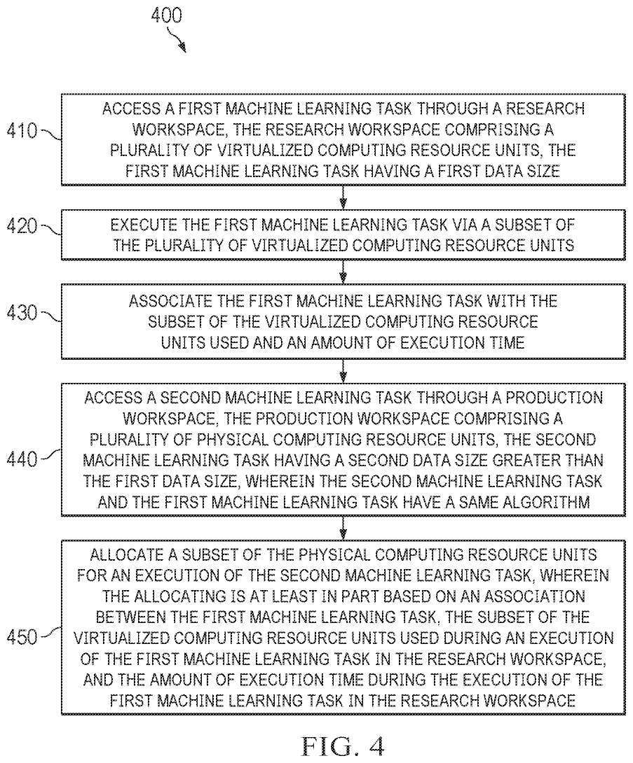

FIG. 4 is a flowchart illustrating a method 400 of allocating computing resources according to various aspects of the present disclosure. The method 400 may be performed by a system that includes a processor and a non-transitory computer-readable medium associated with or managed by any of the entities or systems described herein. The computer-readable medium has instructions stored thereon, where the instructions are executable by the processor to cause the system to perform the various steps of the method 400.

The method 400 includes a step 410 to access a first machine learning task through a research workspace. The research workspace comprises a plurality of virtualized computing resource units. The first machine learning task has a first data size.

The method 400 includes a step 420 to execute the first machine learning task via a subset of the plurality of virtualized computing resource units.

The method 400 includes a step 430 to associate the first machine learning task with the subset of the virtualized computing resource units used and an amount of execution time.

The method 400 includes a step 440 to access a second machine learning task through a production workspace. The production workspace comprises a plurality of physical computing resource units, the second machine learning task having a second data size greater than the first data size. The second machine learning task and the first machine learning task have a same algorithm.

The method 400 includes a step 450 to allocate a subset of the physical computing resource units for an execution of the second machine learning task. The allocation is at least in part based on an association between the first machine learning task, the subset of the virtualized computing resource units used during an execution of the first machine learning task in the research workspace, and the amount of execution time during the execution of the first machine learning task in the research workspace.

In some embodiments, each virtualized computing resource units corresponds to a portion of a physical hardware processor or a portion of a physical electronic memory.

In some embodiments, the physical computing resource units comprise computing resources in a decentralized environment, such as an edge computing environment.

In some embodiments, the first machine learning task is one of a plurality of machine learning tasks submitted to the research workspace. The duplicative ones of the machine learning tasks may be filtered out before a rest of the machine learning tasks (including the first machine learning task) are submitted to the research workspace.

In some embodiments, the allocation of step 450 comprises: dividing each of the physical computing resource units into a plurality of blocks, and allocating one or more blocks from the subset of the physical computing resource units for the execution of the second machine learning task. In some embodiments, the method 400 further comprises monitoring, in the production workspace, which of the one or more blocks have been allocated and which other blocks of the plurality of blocks are idle. In some embodiments, the allocating is performed at least in part using a scheduler software program within the production workspace. In some embodiments, the allocating is performed at least in part using a scheduler software program within the production workspace. In some embodiments, the allocating is performed by extrapolating, based on a difference between the first data size and the second data size and further based on the subset of the virtualized computing resource units and the amount of execution time used during the execution of the first machine learning task in the research workspace, how much time or how much of the physical computing resource units are needed to complete the execution of the second machine learning task. In some embodiments, an amount of time needed to complete the execution of the second machine learning task is defined according to a Service-Level Agreement (SLA), and the extrapolating further comprises calculating how much of the physical computing resource units are needed to complete the execution of the second machine learning task in order to meet the amount of time defined according to the SLA.

In some embodiments, the associating step 430 comprises recording, for the first machine learning task via an electronic table maintained within the research workspace, the subset of the virtualized computing resource units used and the amount of execution time for each individual virtualized computing resource unit. In some embodiments, the associating step 430 further comprises associating the first machine learning task with an idle rate for each of the virtualized computing resource units in the subset.

It is also understood that additional method steps may be performed before, during, or after the steps 410-450 discussed above. For example, the method 400 may include a step of: before the accessing the second machine learning task through the production workspace, promoting the first machine learning task to be production-ready. In some embodiments, after the resources are allocated, a transaction request may be received, and the second machine learning model may be accessed in the production space. The transaction request may be processed using the machine learning model. For reasons of simplicity, other additional steps are not discussed in detail herein.

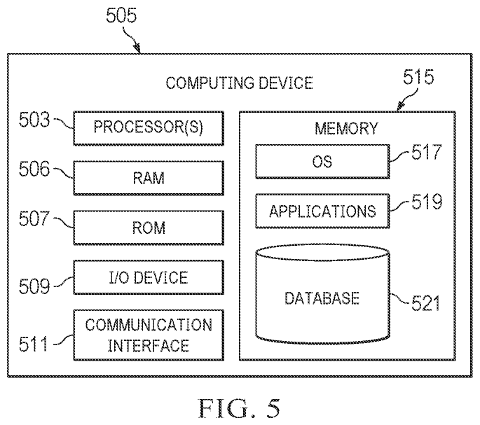

Turning now to FIG. 5, a computing device 505 that may be used with one or more of the computational systems is described. The computing device 505 may be used to implement various computing devices discussed above with reference to FIGS. 1-8. The computing device 505 may include a processor 503 for controlling overall operation of the computing device 505 and its associated components, including RAM 506, ROM 507, input/output device 509, communication interface 511, and/or memory 515. A data bus may interconnect processor(s) 503, RAM 506, ROM 507, memory 515, I/O device 509, and/or communication interface 511. In some embodiments, computing device 505 may represent, be incorporated in, and/or include various devices such as a desktop computer, a computer server, a mobile device, such as a laptop computer, a tablet computer, a smart phone, any other types of mobile computing devices, and the like, and/or any other type of data processing device.

Input/output (I/O) device 509 may include a microphone, keypad, touch screen, and/or stylus motion, gesture, through which a user of the computing device 505 may provide input, and may also include one or more speakers for providing audio output and a video display device for providing textual, audiovisual, and/or graphical output. Software may be stored within memory 515 to provide instructions to processor 503 allowing computing device 505 to perform various actions. For example, memory 515 may store software used by the computing device 505, such as an operating system 517, application programs 519, and/or an associated internal database 521. The various hardware memory units in memory 515 may include volatile and nonvolatile, removable and non-removable media implemented in any method or technology for storage of information such as computer-readable instructions, data structures, program modules, or other data. Memory 515 may include one or more physical persistent memory devices and/or one or more non-persistent memory devices. Memory 515 may include, but is not limited to, random access memory (RAM) 506, read only memory (ROM) 507, electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by processor 503.

Communication interface 511 may include one or more transceivers, digital signal processors, and/or additional circuitry and software for communicating via any network, wired or wireless, using any protocol as described herein.

Processor 503 may include a single central processing unit (CPU), which may be a single-core or multi-core processor, or may include multiple CPUs. Processor(s) 503 and associated components may allow the computing device 505 to execute a series of computer-readable instructions to perform some or all of the processes described herein. Although not shown in FIG. 5, various elements within memory 515 or other components in computing device 505, may include one or more caches, for example, CPU caches used by the processor 503, page caches used by the operating system 517, disk caches of a hard drive, and/or database caches used to cache content from database 521. For embodiments including a CPU cache, the CPU cache may be used by one or more processors 503 to reduce memory latency and access time. A processor 503 may retrieve data from or write data to the CPU cache rather than reading/writing to memory 515, which may improve the speed of these operations. In some examples, a database cache may be created in which certain data from a database 521 is cached in a separate smaller database in a memory separate from the database, such as in RAM 506 or on a separate computing device. For instance, in a multi-tiered application, a database cache on an application server may reduce data retrieval and data manipulation time by not needing to communicate over a network with a back-end database server. These types of caches and others may be included in various embodiments, and may provide potential advantages in certain implementations of devices, systems, and methods described herein, such as faster response times and less dependence on network conditions when transmitting and receiving data.

Although various components of computing device 505 are described separately, functionality of the various components may be combined and/or performed by a single component and/or multiple computing devices in communication without departing from the invention.

One aspect of the present disclosure pertains to a method. The method includes: accessing a first machine learning task through a research workspace, the research workspace comprising a plurality of virtualized computing resource units, the first machine learning task having a first data size; executing the first machine learning task via a subset of the plurality of virtualized computing resource units; associating the first machine learning task with the subset of the virtualized computing resource units used and an amount of execution time; accessing a second machine learning task through a production workspace, the production workspace comprising a plurality of physical computing resource units, the second machine learning task having a second data size greater than the first data size, wherein the second machine learning task and the first machine learning task have a same algorithm; and allocating a subset of the physical computing resource units for an execution of the second machine learning task, wherein the allocating is at least in part based on an association between the first machine learning task, the subset of the virtualized computing resource units used during an execution of the first machine learning task in the research workspace, and the amount of execution time during the execution of the first machine learning task in the research workspace.

Another aspect of the present disclosure pertains to a system. The system includes a processor and a non-transitory computer-readable medium having stored thereon instructions that are executable by the processor to cause the system to perform operations comprising: receiving, via a non-production workspace, a data analysis job; executing the data analysis job in the non-production workspace via a plurality of virtualized computing resource units, the virtualized computing resource units each providing a fraction of processing power offered by physical computing resources that are located outside the non-production workspace; recording statistics of an execution of the data analysis job in the non-production workspace; sending the data analysis job to a production workspace based on a determination that the data analysis job is production-ready; and determining, based on the statistics recorded during the execution of the data analysis job in the non-production workspace, how the physical computing resources should be allocated to execute the data analysis job in the production workspace.

Yet another aspect of the present disclosure pertains to a non-transitory machine-readable medium having stored thereon machine-readable instructions executable to cause a machine to perform operations comprising: accessing a first version of a machine learning job in a non-production environment, the first version of the machine learning job having a first data size, the non-production environment comprising a plurality of virtualized computing resource units, wherein each of the virtualized computing resource units provides a fraction of computing power provided by a physical computing device, the fraction being less than 1; executing the first version of the machine learning job in the non-production environment via a subset of the virtualized computing resource units; extracting data from an execution of the first version of the machine learning job in the non-production environment, wherein the data extracted comprises a total amount of execution time, which subset of the virtualized computing resource units were used in the execution, or a utilization rate of each of the virtualized computing resource units of the subset during the execution; promoting, based on a satisfaction of a predetermined condition, the first version of the machine learning job to a second version of the machine learning job that is production-ready; accessing the second version of the machine learning job in a production environment that comprises a plurality of the physical computing devices, the second version of the machine learning job having a second data size that is greater than the first data size; and determining, based on a difference between the first data size and the second data size and further based on the data extracted from the execution of the first version of the machine learning job in the non-production environment, how the plurality of the physical computing devices should be allocated to execute the second version of the machine learning job in the production environment.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A method, comprising:
accessing a first machine learning task through a research workspace, the research workspace comprising a plurality of virtualized computing resource units, the first machine learning task having a first data size;
executing the first machine learning task via a subset of the plurality of virtualized computing resource units;
associating the first machine learning task with the subset of the virtualized computing resource units used and an amount of execution time;
accessing a second machine learning task through a production workspace, the production workspace comprising a plurality of physical computing resource units, the second machine learning task having a second data size greater than the first data size, wherein the second machine learning task and the first machine learning task have a same algorithm; and
allocating, during an execution of the second machine learning task, a subset of the physical computing resource units to perform the execution of the second machine learning task, wherein the allocating is at least in part based on an association between the first machine learning task, the subset of the virtualized computing resource units used during an execution of the first machine learning task in the research workspace, and the amount of execution time during the execution of the first machine learning task in the research workspace.

2. The method of claim 1, wherein each virtualized computing resource units corresponds to a portion of a physical hardware processor or a portion of a physical electronic memory.

3. The method of claim 1, wherein the physical computing resource units comprise computing resources in a decentralized environment.

4. The method of claim 1, wherein the first machine learning task is one of a plurality of machine learning tasks submitted to the research workspace, and wherein the method further comprises: filtering out duplicative ones of the machine learning tasks before submitting a rest of the machine learning tasks including the first machine learning task to the research workspace.

5. The method of claim 1, wherein the allocating comprises:
dividing each of the physical computing resource units into a plurality of blocks; and
allocating one or more blocks from the subset of the physical computing resource units for the execution of the second machine learning task;
and wherein the method further comprises monitoring, in the production workspace, which of the one or more blocks have been allocated and which other blocks of the plurality of blocks are idle.

6. The method of claim 1, wherein the associating comprises recording, for the first machine learning task via an electronic table maintained within the research workspace, the subset of the virtualized computing resource units used and the amount of execution time for each individual virtualized computing resource unit.

7. The method of claim 1, wherein the associating further comprises associating the first machine learning task with an idle rate for each of the virtualized computing resource units in the subset.

8. The method of claim 1, further comprising: before the accessing the second machine learning task through the production workspace, promoting the first machine learning task to be production-ready.

9. The method of claim 1, wherein the allocating is performed at least in part using a scheduler software program within the production workspace.

10. The method of claim 1, wherein the allocating is performed by extrapolating, based on a difference between the first data size and the second data size and further based on the subset of the virtualized computing resource units and the amount of execution time used during the execution of the first machine learning task in the research workspace, how much time or how much of the physical computing resource units are needed to complete the execution of the second machine learning task.

11. The method of claim 10, wherein an amount of time needed to complete the execution of the second machine learning task is defined according to a Service-Level Agreement (SLA), and wherein the extrapolating further comprises calculating how much of the physical computing resource units are needed to complete the execution of the second machine learning task in order to meet the amount of time defined according to the SLA.

12. A system comprising:
a processor; and
a non-transitory computer-readable medium having stored thereon instructions that are executable by the processor to cause the system to perform operations comprising:
receiving, via a non-production workspace, a data analysis job;
executing the data analysis job in the non-production workspace via a plurality of virtualized computing resource units, the virtualized computing resource units each providing a fraction of processing power offered by physical computing resources that are located outside the non-production workspace;
recording statistics of an execution of the data analysis job in the non-production workspace;
sending the data analysis job to a production workspace based on a determination that the data analysis job is production-ready;
determining, based on the statistics recorded during the execution of the data analysis job in the non-production workspace, how the physical computing resources should be allocated to execute the data analysis job in the production workspace; and
allocating the physical computing resources based on the determining.

13. The system of claim 12, wherein the statistics recorded comprise a data size, a total amount of execution time, a number of the virtualized computing resource units used, or an idle rate of each of the virtualized computing resource units.

14. The system of claim 12, wherein:
the data analysis job executed in the non-production workspace comprises training a machine learning model with training data having a first data size;
the data analysis job executed in the production workspace comprises training the machine learning model with training data having a second data size greater than the first data size; and
the determining how the physical computing resources should be allocated is performed at least in part based on a ratio of the first data size and the second data size.

15. The system of claim 12, wherein the operations further comprise receiving a time limit within which the data analysis job needs to be completed in the production workspace, and wherein the determining how the physical computing resources should be allocated is performed at least in part based on the time limit.

16. The system of claim 12, wherein the physical computing resources are configured to perform edge computing.

17. The system of claim 12, wherein:
the physical computing resources comprise a plurality of different Graphics Processing Unit (GPU) cards; and
the determining how the physical computing resources should be allocated comprises:
dividing each of the GPU cards into a plurality of blocks; and
determining how each of the blocks should be allocated to execute the data analysis job in the production workspace.

18. A non-transitory machine-readable medium having stored thereon machine-readable instructions executable to cause a machine to perform operations comprising:
accessing a first version of a machine learning job in a non-production environment, the first version of the machine learning job having a first data size, the non-production environment comprising a plurality of virtualized computing resource units, wherein each of the virtualized computing resource units provides a fraction of computing power provided by a physical computing device, the fraction being less than 1;
executing the first version of the machine learning job in the non-production environment via a subset of the virtualized computing resource units;
extracting data from an execution of the first version of the machine learning job in the non-production environment, wherein the data extracted comprises a total amount of execution time, which subset of the virtualized computing resource units were used in the execution, or a utilization rate of each of the virtualized computing resource units of the subset during the execution;
promoting, based on a satisfaction of a predetermined condition, the first version of the machine learning job to a second version of the machine learning job that is production-ready;
accessing the second version of the machine learning job in a production environment that comprises a plurality of the physical computing devices, the second version of the machine learning job having a second data size that is greater than the first data size;
determining, based on a difference between the first data size and the second data size and further based on the data extracted from the execution of the first version of the machine learning job in the non-production environment, how the plurality of the physical computing devices should be allocated to execute the second version of the machine learning job in the production environment; and
allocating the plurality of the physical computing resources based on the determining.

19. The non-transitory machine-readable medium of claim 18, wherein the second version of the machine learning job has a specified time limit, and wherein the determining is performed at least in part based on a ratio between the specified time limit and the total amount of execution time.

20. The non-transitory machine-readable medium of claim 18, wherein the determining is performed at least in part by maximizing a utilization rate of each of the physical computing devices that has been allocated to perform the execution of the second version of the machine learning job in the production environment.
